(19) United States
(12) Patent Application Publication
(10) Pub. No.: US 2005/0145729 A1
(43) Pub. Date: Jul. 7, 2005

(54) Method and apparatus for energy efficient particle-size reduction of particulate material

(76) Inventors: Mark J. Stachowski, Fairport, NY (US); Stewart W. Blair, Rochester, NY (US)

Correspondence Address: Mark G. Bocchetti;Patent Legal Staff, Eastman Kodak Company, 343 State Street, Rochester, NY, 14650-2201, US

(21) Appl. No.: 11/011,693

(22) Filed: Dec. 14, 2004

Related U.S. Application Data
(60) Provisional application No. 60/531,344, filed on Dec. 19, 2003.

(51) Int. Cl. B02C 1/00

(52) U.S. Cl. 241/27

(57) ABSTRACT

An apparatus (10, 100) for reducing the particle size of a bulk particulate or powder material includes one or more first particle-size reducing stages (12, 120) and a final particle-size reducing stage (14, 140). The first particle-size reducing stage (12, 120) receives the bulk material and reduces the particle size thereof to an intermediate particle size. The final particle-size reducing stage (14, 140) receives the bulk material having the intermediate particle size and further reduces the particle size thereof from the intermediate particle size to a desired particle size.

### FIELD OF THE INVENTION

The present invention relates to the production of fine particulate material, such as toner for use in electrophotographic printing machines and other fine particulate material.

### BACKGROUND OF THE INVENTION

The toner used in electrophotographic printing machines is a blend of materials, including plastic resins, coloring pigments and other ingredients. Most toners are produced in bulk using a melt mixing or hot compounding process. Plastic resins, carbon black, magnetic iron oxides, waxes and charge control agents are blended together while in a molten state to thereby form a hot paste having a consistency similar to cake mix. This mixture is then cooled, typically by forming it into slabs on a cooling belt or by pelletizing the mixture and cooling the pellets. The raw toner is then ground or pulverized into a toner powder by, for example, jet mills or air-swept hammer mills. This process produces a powder having a wide range of particle sizes. The toner powder is then sifted or classified to remove over-size and under-size toner particles, blended with additives to adjust flow and electrostatic properties, and packaged for use. Generally, toner having a smaller or finer particle size is preferable.

Toner particle size is reduced by one of several particle size reducing processes, such as, for example, milling, pulverizing, jet milling, air milling or grinding. The ability to reduce particle size is limited by various factors, including the fracture mechanics of the binder resin, which, in turn, is affected by the dispersion of the other ingredients within the toner and the adhesion thereof to the binder resin. The ability to reduce toner particle size is further limited by the inherent toughness of the toner binder. Thus, for a given or maximum amount of input energy, a particle size reduction process is limited to producing particles having a certain minimum average particle size.

Therefore, what is needed in the art is a method and apparatus that produces smaller toner particles.

Furthermore, what is needed in the art is a method and apparatus that produces smaller toner particles for a given or fixed amount of input energy.

Moreover, what is needed in the art is a method and apparatus that requires less input energy in order to produce toner particles of a given maximum size.

### SUMMARY OF THE INVENTION

The present invention provides an apparatus and energy-efficient method for reducing the particle size of a bulk particulate or powder material.

The invention provides, in one form thereof, one or more first particle-size reducing stages and a final particle-size reducing stage. The first particle-size reducing stage receives the bulk material and reduces the particle size thereof to an intermediate particle size. The final particle-size reducing stage receives the bulk material having the intermediate particle size and further reduces the particle size thereof from the intermediate particle size to a desired particle size.

An advantage of the present invention is that a desired particle size is obtained with reduced input energy relative to a conventional single-stage particle-size reduction process.

Yet another advantage of the present invention is that for a fixed input energy smaller particle sizes are obtained relative to a conventional single-stage particle-size reduction process.

### BRIEF DESCRIPTION OF THE DRAWINGS

The above-mentioned and other features and advantages of this invention, and the manner of attaining them, will become apparent and be better understood by reference to the following description of the invention in conjunction with the accompanying drawings, wherein:

FIG. 1 is a schematic diagram of one embodiment of a multi-stage particle-size reducing apparatus of the present invention;

FIG. 2 is a schematic diagram of another embodiment of a particle-size reducing apparatus of the present invention; and

FIG. 3 is a plot showing the input energy required to achieve exemplary particle sizes using a conventional single-stage particle-size reducing method versus the input energy required to achieve the same exemplary particle sizes using the multi-stage particle-size reducing method of the present invention.

Corresponding reference characters indicate corresponding parts throughout the several views. The exemplifications set out herein illustrate preferred embodiments of the invention, and such exemplifications are not to be construed as limiting the scope of the invention in any manner.

### DETAILED DESCRIPTION OF THE DRAWINGS

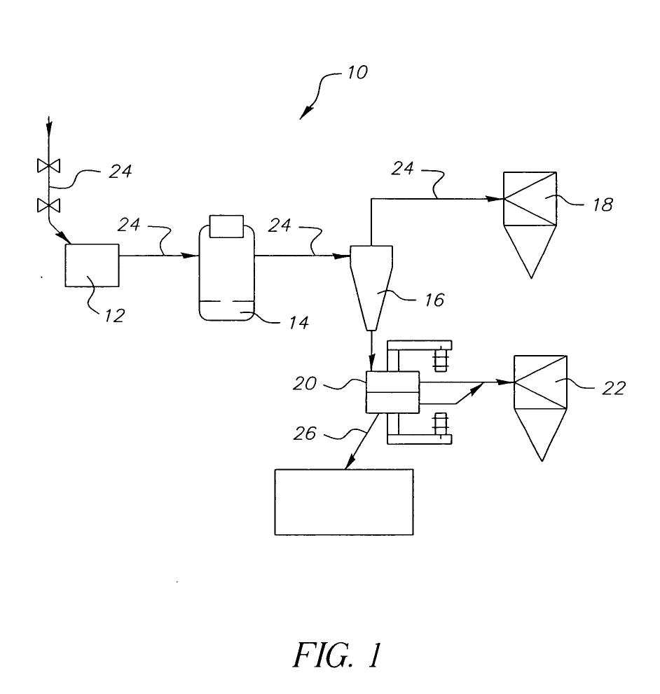

Referring now to the drawings, and particularly to FIG. 1, there is shown one embodiment of a multi-stage particle-size reducing apparatus of the present invention. Apparatus 10 is used to reduce the particle size of raw or bulk toner for use in electrophotographic printing machines. Alternatively, apparatus 10 is used to reduce the particle size of other fine particulate or powder material, such as, for example, carbon, silica, alumina, titanium dioxide, talc, plastic resins, and other powdered materials that are classified in groups A, B, and/or C of a Gelden Chart.

Generally, apparatus 10 processes the toner or particulate material through one or more first particle-size reducing stages to produce particles of a reduced, intermediate volume-average particle size. The reduced-size particles are then processed through a final particle-size reducing stage that produces particles of a further reduced and desired volume-average particle size.

Apparatus 10 includes one or more first-stage particle-size reducing devices or stages 12 (only one shown), a second or final-stage particle-size reducing device 14, cyclone 16, dust collector 18, classifier 20 and dust collector 22. Bulk particulate material, such as toner, is fed or supplied to first-stage particle-size reducing device 12 via a conduit 24 from a reservoir hopper or other bulk material container (not shown). The particulate material is preferably processed by apparatus 10 in a generally continuous process and therefore, apparatus 10 may include double-flap valves or other such metering devices (not shown). Alternatively, a batch process can be used such that bulk particulate material from device or stage 12 is supplied to device or stage 14 in batches. A pressurized flow of air or inert gas (not shown) is connected to each of the components of apparatus 10, and as is known in the art facilitates the movement of the bulk particulate material through apparatus 10.

First-stage particle-size reducing device or stage 12 is configured as, for example, a mechanical mill pulverizer. However, it is to be understood that first-stage particle-size reducing device 12 can be alternately configured as virtually any type of pulverizer or particle size reduction apparatus, such as, for example, a milling device, pulverizer, jet or air mill pulverizer, hammer mill, pin mill, cutting grinder, air classifying mill, etc. First-stage particle-size reducing device 12 receives bulk particulate material from conduit 24 and is operable to reduce the volume-average particle size of that particulate or powder material to a predetermined and intermediate volume-average particle size, as will be explained more particularly hereinafter.

Final-stage particle-size reducing device 14 is configured as, for example, a Hosokawa Alpine 400 TFG jet mill pulverizer. However, it is to be understood that final-stage particle-size reducing device 14 can be alternately configured as a different type of particle-size reducing device or pulverizer, such as, for example, a spiral jet mill pulverizer, an opposed jet-mill pulverizer, fluid-bed jet mill pulverizer, or virtually any other suitable type or configuration of particle size reduction apparatus or pulverizer. Final-stage particle-size reducing device 14 receives the bulk particulate material having a predetermined intermediate volume-average particle size from first-stage particle-size reducing device 12 via conduit 24, and is operable to reduce the particle size of the particulate material from the intermediate particle size to a final or desired volume-average particle size, as will also be explained more particularly hereinafter.

Cyclone 16 is a conventional cyclone, and receives particulate material, having the final or desired particle size from final-stage particle-size reducing device 14 via conduit 24. Cyclone 16 collects the particulate material from final-stage particle-size reducing device 14, and is operable to separate or remove the particulate material from the air stream. Further, cyclone 16 removes dust and/or undesirably small or fine particles from the stream of air or inert gas. The undesirably fine and/or dust particles, often referred to collectively as super-fine particles, are carried by the pressurized flow of air or gas from cyclone 16 into dust collector 18 via conduit 24.

Classifier 20 receives the particulate material from cyclone 16, and sorts, or classifies the particulate material. More particularly, classifier 20 separates the particulate material based on particle size, and delivers particulate material having a desired range of particle sizes (i.e., classified product) to outlet 26. Outlet 26 is connected to other particulate material processing equipment, such as, for example, a bulk container or bulk container-filling apparatus.

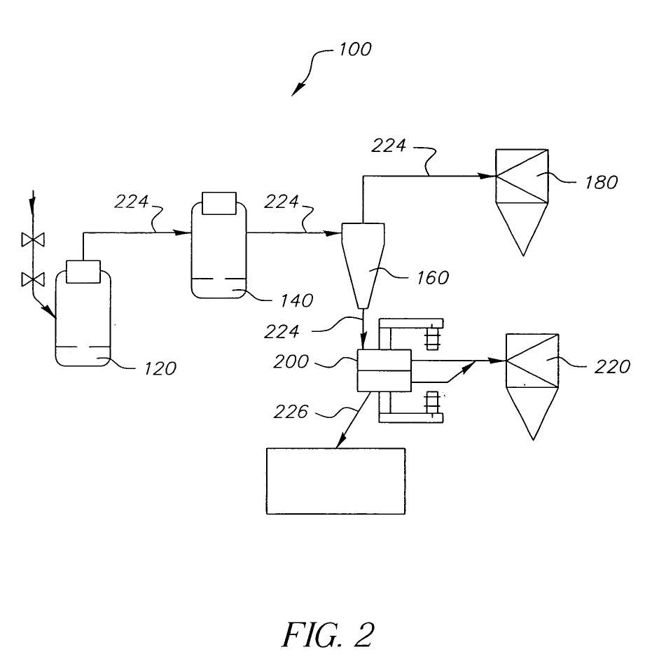

Referring now to FIG. 2, a second embodiment of a multi-stage particle-size reducing apparatus of the present invention is shown. Apparatus 100 is, like apparatus 10, used to produce raw toner for use in electrophotographic printing machines or other fine particulate or powder material, such as, for example, carbon, silica, alumina, titanium dioxide, talc, plastic resins, and other powdered materials that are classified in groups A, B, and/or C of a Gelden Chart.

Generally, apparatus 100 processes the particulate or powder material through one or more first particle-size reducing devices or stages that produce particles of a reduced and predetermined intermediate volume-average particle size. The intermediate-sized particles are then processed through a second or final particle-size reduction device or stage that produces particles of a further reduced, final or desired volume-average particle size.

Apparatus 100 includes first-stage particle-size reducing device 120, final-stage particle-size reducing device 140, cyclone 160, dust collector 180, classifier 200, and dust collector 220. Bulk particulate material, such as toner, is fed or supplied to first-stage particle-size reducing device 120 via a conduit 240 from a reservoir hopper or other bulk material container (not shown). Thus, apparatus 100 is generally similar to apparatus 10. The particulate material is preferably processed by apparatus 100 in a generally continuous process and therefore, apparatus 100 may include double-flap valves or other such metering devices (not shown). Alternatively, a batch process can be used such that bulk particulate material from device 120 is supplied to device 140 in batches. Unlike apparatus 10, which has a first-stage pulverizer device configured as a mechanical pulverizer mill, the first-stage particle-size reducing device 120 of apparatus 100 is configured as a jet-mill pulverizer, such as, for example, a Hosokawa Alpine 400 TFG jet mill pulverizer. Thus, each of the particle-size reducing devices or stages 120 and 140 of apparatus 100 are configured as jet mill pulverizers.

In use, apparatus 10 and/or apparatus 100 perform the multi-stage particle-size reducing method of the present invention to thereby reduce the particle size of the particulate material from its bulk or raw condition to one or more intermediate particle sizes and then to a final or desired particle size. Generally, in one or more first pulverization or particle-size reducing stages the method of the present invention reduces the volume-average particle size of the particulate material to an intermediate particle size, such as, for example, from approximately 40μ to as small as approximately 15μ. In a second or final pulverization or particle-size reducing stage the method of the present invention further reduces the volume-average particle size of the particulate material to a second, desired or final particle size, such as, for example, from approximately 8.0μ to approximately 4.0μ or less. Relative to a conventional single-stage pulverization process, the multi-stage pulverization or particle-size reduction method of the present invention requires significantly less input energy to produce particulate matter of a given final or desired particle size.

It must be particularly noted that, although the multi-stage pulverization or particle size-reduction method of the present invention is hereinafter described with reference to an exemplary embodiment of a two-stage pulverization process, it is to be understood that the method of the present invention can include any number of pulverization or particle-size reducing stages.

When used to process toner for use in electrophotographic printing machines, apparatus 10 and/or apparatus 100 receive bulk toner material that has a particle size of, for example, from approximately 250μ to approximately 700μ. The one or more first-stage particle-size reducing devices (i.e., pulverizers 12 or 120) reduce the particle size of the toner material to a first or intermediate size, such as, for example, from approximately 100μ to approximately 15μ volume-average particle size. The final-stage particle-size reducing device (i.e., final-stage particle-size reducing devices 14 or 140) further reduces the size of the toner material to the second, final or desired volume-average particle size of less than approximately 10μ, and preferably to a particle size of from approximately 8μ to approximately 4μ or less.

The following examples illustrate the advantages of the multi-stage pulverization or particle-size reduction method of the present invention relative to a conventional, single-stage pulverization or particle size reduction method.

### EXAMPLE 1

A first magenta toner extrudate was prepared by melt blending a pigment flush obtained from BASF Aktiengesellschaft of Ludwigshafen, Germany, as Lupreton Red 1255 in a 30 millimeter twin-screw extruder with Binder C polyester of Kao Corporation of Tokyo, Japan, and with 2 parts per hundred (pph) Bontron E-84 charge agent such that the final pigment concentration was 4.5 parts of pigment per 100 parts resin by weight. These concentrations were chosen for specific colorimetric properties and are not relevant to the invention. The two toner extrudates were each individually cooled out of the extruder through a chill-belt, and granulated. The resultant toner extrudate granules were of approximately 500μ in size.

The first magenta toner extrudate was then pulverized and classified to the desired volume-average particle size of from approximately 7.5μ to approximately 8.0μ. Similarly, a second magenta toner extrudate was prepared using methods identical to the above-described methods, but having a higher pigment concentration of 6.0 parts of pigment per 100 parts of resin by weight, for pulverizing and classifying to the desired volume-average particle size of from approximately 5.5μ to approximately 6.0μ.

The first magenta toner preparation was pulverized using a conventional single-stage pulverization process to its desired volume-average particle size (i.e., approximately 7.5μ to 8.0μ) by a Hosokawa-Alpine 500 TFG jet mill pulverizer with a 6 bar nozzle pressure. The second magenta toner preparation was also pulverized using a conventional single-stage pulverization process to its desired volume-average particle size (i.e., approximately 5.5μ to 6.0μ) on a Hosokawa-Alpine 400 TFG jet mill pulverizer. It is to be understood that the model number of the mill is specific to the size of the mill, and is independent of the experimental data presented herein.

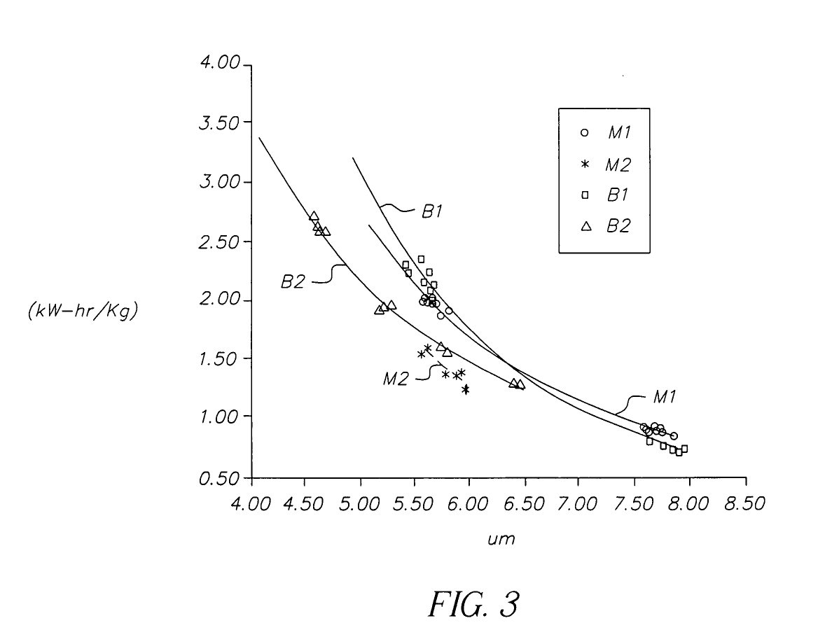

FIG. 3 shows the pulverization energy required to pulverize each of the toner preparations to their respective desired volume-average particle sizes. More particularly, curve M1 of FIG. 3 shows that reducing the particle size of the first magenta toner to its desired volume-average particle size of from approximately 7.5μ to 8.0μ using a single-stage pulverizing method required approximately 0.8 to approximately 1.0 kilowatt-hours per kilogram (kW-hr/Kg). Similarly, curve M1 of FIG. 3 shows that reducing the particle size of the second magenta toner to its desired volume-average particle size of from approximately 5.5μ to 6.0μ using a single-stage pulverizing method required approximately 1.9 to approximately 2.1 kW-hr/Kg.

In contrast, the multi-stage pulverization or particle-size reduction method of the present invention requires significantly less energy to achieve the same results. In the present example, the multi-stage particle-size reducing method of the present invention is used to reduce the toner particle size to an intermediate volume-average particle size of from approximately 22μ to 26μ in first-stage particle-size reducing devices 12 or 120. Thereafter, the toner particle size is further reduced to its final or desired volume-average particle size of from approximately 5.5μ to 6.0μ in final-stage particle-size reducing device 14 or 140.

Curve M2 (FIG. 3) shows that reducing the magenta toner to its desired or final volume-average particle size of from approximately 5.5μ to 6.0μ using the multi-stage pulverizing or particle-size reducing method of the present invention consumes or requires a total of from approximately 1.3 to approximately 1.6 kW-hr/Kg, whereas the single-stage particle-size reducing process as discussed above requires from approximately 1.9 to approximately 2.1 kW-hr/Kg.

Table 1 summarizes the above results, and indicates that producing a magenta toner having a final or desired volume-average particle size of approximately 5.7μ using a single-stage pulverizing process requires approximately 2.0 kW-hr/Kg, and occurs at a rate of approximately 23.7 kg/hr. In contrast, the multi-stage pulverization method of the present invention produces essentially the same magenta toner, i.e., a magenta toner having a final or desired volume-average particle size of approximately 5.8μ, while requiring a total of only 1.6 kW-hr/Kg and does so at a significantly higher rate of approximately 29.2 kg/hr.

TABLE 1

| | | Size | |
|---|---|---|---|
| | | (volume median, | |
| | Rate | via Coulter | Specific Energy |
| Toner | (Kg/hr) | counter ave, μ) | (kW-hr/kg) |
| Magenta Single-stage | 23.7 | 5.7 | 2.0 |
| Magenta 1^{st} Stage | 224.6 | 23.4 | 0.2 |
| Magenta 2^{nd} Stage | 29.2 | 5.8 | 1.4 |
| Total (2-stage Magenta) | | | 1.6 |

Thus, the multi-stage pulverization method of the present invention, requires approximately 0.4 kW-hr/Kg less energy than the conventional single-stage reduction process, to produce magenta toner particles having substantially the same size. Further, the multi-stage pulverization method of the present invention produces magenta toner at a rate that is approximately 5.5 kg/hr higher than the rate of the conventional single-stage pulverization process. Alternatively stated, the multi-stage pulverization method of the present invention produces magenta toner particles of a significantly smaller volume-average particle size for a given amount of pulverization input energy relative to the volume-average particle size produced by the conventional single-stage pulverization process for the same given amount of energy input.

### EXAMPLE 2

A first black toner extrudate was prepared by melt blending Regal 330 carbon black pigment from Cabot Corporation, Billerica, Mass. USA in a 30 mm twin-screw extruder with Binder C polyester of Kao Corporation of Tokyo, Japan, and with 2 pph Bontron E-84 charge agent such that the final pigment concentration was 3.0 parts of pigment per 100 parts resin by weight. These concentrations were chosen, for specific colorimetric properties not pertinent to the invention. The two toner extrudates were each individually cooled out of the extruder through a chill-belt, and granulated. The resultant toner extrudate granules were of approximately 500 microns in size.

The first black toner extrudate was pulverized and classified to the desired volume-average particle size of from approximately 7.5μ to approximately 8.0μ. Similarly, a second black toner extrudate was prepared using methods identical to the above-described methods, but having a higher pigment concentration of 4.5 parts of carbon black pigment per 100 parts resin by weight) for pulverizing and classifying to the desired volume-average particle size of from approximately 5.5μ to approximately 6.0μ.

The first black toner preparation was pulverized using a conventional single-stage pulverization process to its desired volume-average particle size (i.e., approximately 7.5μ to 8.0μ) using a Hosokawa-Alpine 500 TFG jet mill pulverizer with a 6 bar nozzle pressure. Similarly, the second black toner preparation was pulverized using a conventional single-stage pulverization process to its desired volume-average particle size (i.e., approximately 5.5 to 6.0μ) on a Hosokawa-Alpine 400 TFG jet mill pulverizer. It is to be understood that the model number of the mill is specific to the size of the mill, and is independent of the experimental data presented herein.

FIG. 3 shows the pulverization energy required to pulverize each of the toner preparations to their respective desired volume-average particle sizes. More particularly, curve B1 of FIG. 3 shows that reducing the particle size of the first black toner to its desired or final volume-average particle size of from approximately 7.5μ to 8.0μ using a conventional single-stage pulverization process required approximately 0.8 to approximately 0.9 kW-hr/Kg. Similarly, curve B1 of FIG. 3 also shows that reducing the particle size of the second black toner to its desired or final volume-average particle size of from approximately 5.5μ to 6.0μ using a conventional single-stage pulverization process required approximately 2.1 to approximately 2.4 kW-hr/Kg.

In the present example, the multi-stage particle-size reducing method of the present invention is used to reduce the particle size to an intermediate volume-average particle size of from approximately 20 to 24μ in first-stage particle-size reducing devices 12 or 120. Thereafter, the toner particle size is further reduced to its desired or final volume-average particle size of from approximately 5.5μ to 6.0μ in final-stage particle-size reducing device 14 or 140.

Curve B2 (FIG. 3) shows that reducing the black toner to its desired volume-average particle size of from approximately 5.5μ to 6.0μ using the multi-stage pulverizing or particle-size reducing method of the present invention requires a total of approximately 1.6 to approximately 1.7 kW-hr/Kg, whereas the single-stage particle-size reducing process requires from approximately 2.1 to approximately 2.4 kW-hr/Kg.

Table 2 summarizes the above results, and indicates that producing a black toner having a final or desired volume-average particle size of approximately 5.6μ using a conventional single-stage pulverizing process requires approximately 2.2 kW-hr/Kg and occurs at a rate of approximately 21.7 kg/hr. In contrast, the multi-stage pulverization process of the present invention produces substantially the same black toner, i.e., black toner having a final or desired volume-average particle size of approximately 5.8μ, while requiring a total energy of only 2.0 kW-hr/Kg and does so at a significantly higher rate of approximately 25.3 kg/hr.

TABLE 2

| | | Size | |
|---|---|---|---|
| | | (volume median, | |
| | Rate | via Coulter | Specific Energy |
| Toner | (Kg/hr) | counter ave, μ) | (kW-hr/kg) |
| Black single-stage | 21.7 | 5.6 | 2.2 |
| Black 1st Stage | 71.9 | 25.9 | 0.4 |
| Black 2nd Stage | 25.3 | 5.8 | 1.6 |
| Total (2-stage Black) | | | 2.0 |

Thus, in the present example, the multi-stage pulverization method of the present invention, requires approximately 0.2 kW-hr/Kg less energy, than the conventional single-stage reduction process, to produce black toner particles having substantially the same particle size. Further, the multi-stage pulverization method of the present invention produces black toner at a higher rate than does the conventional single-stage pulverization process. Alternatively stated, the multi-stage pulverization method of the present invention produces black toner particles having a significantly smaller volume-average particle size for a given amount of pulverization input energy relative to the volume-average particle size produced by the conventional single-stage pulverization process for the same given amount of energy input.

### EXAMPLE 3

A magenta toner extrudate was prepared by melt blending a pigment flush obtained from BASF Aktiengesellschaft of Ludwigshafen, Germany, as Lupreton Red 1255 in a 30 mm twin-screw extruder with Binder C polyester of Kao Corporation of Tokyo, Japan, and with 2 pph Bontron E-84 charge agent such that the final pigment concentration was 6.0 parts of pigment per 100 parts resin by weight. These concentrations were chosen, for specific colorimetric properties not pertinent to the invention. The toner extrudate was cooled out of the extruder through a chill-belt, and granulated. The resultant toner granules were of approximately 500μ in size.

Two separate batches T1 and T2 of the magenta toner extrudate were pulverized to respective volume-average particle sizes using a conventional single-stage process. More particularly, batch T1 of magenta toner material was pulverized in a single-stage process to a final or desired volume-average particle size of approximately 6.0μ. A second batch T2 of magenta toner material was similarly pulverized in a single-stage process to a final or desired volume-average particle size of approximately 7.6μ. A Hosokawa-Alpine 100 AFG jet mill pulverizer with a 6.2 bar nozzle pressure was used.

Referring to Table 3, the pulverization rate and particle sizes of the batches T1 and T2 are shown. As shown in Table 3, batch T1 was pulverized to a final or desired volume-average particle size of approximately 6.0μ at a rate of approximately 0.895 kg/hr. Second batch T2 was pulverized to a final or desired volume-average particle size of approximately 7.6μ at a rate of approximately 1.005 kg/hr.

The multi-stage pulverization method of the present invention was also applied to two separate batches of the above-described magenta toner. The particle size of the first multi-stage batch T3 was reduced in a first pulverizing stage to an intermediate volume-average particle size of approximately 74μ, whereas the particle size of the second multi-stage batch T4 was reduced in a first pulverizing stage to an intermediate volume-average particle size of approximately 57μ. In a second pulverizing stage, the particle size of the multi-stage batches T3 and T4 was reduced to a final or desired volume-average particle size of approximately 6.3μ. The first-stage pulverization of batches T3 and T4 was performed using a Hosokawa Micron Powder Systems Model 2 ACM mechanical mill, although virtually any mechanical mill can be used, and the second-stage pulverization was performed using a Hosokawa Micron Powder Systems 100 AFG jet mill pulverizer with a 6.2 bar nozzle pressure.

The above is summarized in Table 3, which shows that multi-stage batch T3 of magenta toner was pulverized to an intermediate volume-average particle size of approximately 74μ at a rate of approximately 10.8 kg/hr, and in a second pulverization stage to a desired volume-average particle size of approximately 6.3μ at a rate of approximately 0.996 kg/hr. The multi-stage batch T4 of magenta toner was pulverized to an intermediate volume-average particle size of approximately 57μ at a rate of approximately 4.8 kg/hr, and in a second pulverization stage to a desired volume-average particle size of approximately 6.4μ at a rate of approximately 1.025 kg/hr.

Comparing the volume-average particle size and rate of toner produced using the multi-stage pulverization method of the present invention with those same quantities resulting from the use of the single-stage pulverization shows that the total energy required by the multi-stage process of the present invention is significantly less than the energy required in the single-stage process.

TABLE 3

| | | Size |
|---|---|---|
| | Rate | (volume median, via |
| Toner | (Kg/hr) | Coulter counter ave, μ) |
| Single-Stage Batch T1 | 0.895 | 6.05 |
| Single-Stage Batch T2 | 1.005 | 7.63 |
| Multi-Stage Batch T3 | | |
| 1st Stage | 10.8 | 73.7 |
| 2nd Stage | 0.996 | 6.27 |
| Multi-Stage Batch T4 | | |
| 1st Stage | 4.8 | 56.78 |
| 2nd Stage | 1.025 | 6.35 |

As the foregoing examples establish, the total energy required to achieve a given volume-average toner particle size using the multi-stage pulverization method of the present invention is significantly less than that required to achieve substantially the same particle size using a conventional single pulverization method. Further, or alternatively, the multi-stage pulverization method of the present invention produces finer or smaller volume-average toner particle sizes for a given amount of input pulverization energy than is produced by a conventional single pulverization method having the same input energy.

While this invention has been described as having preferred embodiments, the present invention can be further modified within the spirit and scope of this disclosure. This application is therefore intended to cover any variations, uses, or adaptations of the present invention using the general principles disclosed herein. Further, this application is intended to cover such departures from the present disclosure as come within the known or customary practice in the art to which this invention pertains and which fall within the limits of the appended claims.

### Parts List

10 Apparatus

12 First-stage Particle-size Reducing Device

14 Final-stage Particle-size Reducing Device

16 Cyclone

18 Dust Collector

20 Classifier

22 Dust Collector

24 Conduit

26 Outlet

100 Apparatus

120 First-stage Particle-size Reducing Device

140 Final-stage Particle-size Reducing Device

160 Cyclone

180 Dust Collector

200 Classifier

220 Dust Collector

240 Conduit

260 Outlet

M1 Curve for first batch of magenta toner

M2 Curve for second batch of magenta toner

B1 Curve for first batch of black toner

B2 Curve for second batch of black toner

T4 Multi-stage toner batch 4

T1 Single-stage toner batch 1

T2 Single-stage toner batch 2

T3 Multi-stage toner batch 3

1. An apparatus for reducing a particle size of a bulk particulate or powder material, comprising:
a first particle-size reducing stage receiving the bulk material and reducing the particle size thereof to an intermediate particle size; and
a final particle-size reducing stage receiving the bulk material having said intermediate particle size and further reducing the particle size thereof to a desired particle size.

2. The apparatus of claim 1, wherein said first particle-size reducing stage comprises one or more particle-size reducing stages.

3. The apparatus of claim 1, wherein said first particle-size reducing stage comprises one of a mechanical mill pulverizer, a jet mill pulverizer, air mill pulverizer, hammer mill pulverizer, pin mill pulverizer, and cutting grinder.

4. The apparatus of claim 1, wherein said final particle-size reducing stage comprises one of a mechanical mill pulverizer, a jet mill pulverizer, an air mill pulverizer, a hammer mill pulverizer, a pin mill pulverizer, and a cutting grinder.

5. The apparatus of claim 1, wherein said first particle-size reducing stage is connected to said final particle-size reducing stage.

6. The apparatus of claim 1, further comprising a cyclone interconnected with and receiving the bulk material from said final particle size reducing apparatus.

7. The apparatus of claim 6, further comprising a dust collector interconnected with said cyclone.

8. The apparatus of claim 6, further comprising a classifier interconnected with and receiving the bulk material from said cyclone.

9. The apparatus of claim 8, further comprising a dust collector interconnected with said classifier.

10. A method for reducing a particle size of a bulk particulate or powdered material, said method comprising:
reducing in one or more first reducing stages the particle size of the bulk material to an intermediate particle size; and
further reducing in a final reducing stage the intermediate particle size to a desired particle size, said final reducing stage conducted separate from said first reducing stage.

11. The method of claim 10, wherein said reducing step comprises pulverizing the bulk particulate material using one of a mechanical mill pulverizer, a jet mill pulverizer, an air mill pulverizer, a hammer mill pulverizer, a pin mill pulverizer, and a cutting grinder.

12. The method of claim 10, wherein said further reducing step comprises pulverizing the bulk particulate material using one of a mechanical mill pulverizer, a jet mill pulverizer, an air mill pulverizer, a hammer mill pulverizer, a pin mill pulverizer, and a cutting grinder.

13. The method of claim 10, wherein the bulk particulate material comprises toner for use in an electrophotographic printing process, said intermediate particle size comprising from approximately 200 microns to approximately 50 microns.

14. The method of claim 10, wherein the bulk particulate material comprises toner for use in an electrophotographic printing process, said intermediate particle size comprising from approximately 100 microns to approximately 20 microns.

15. The method of claim 10, wherein the bulk particulate material comprises toner for use in an electrophotographic printing process, said desired particle size comprising from approximately 25 microns to approximately 10 microns.

16. The method of claim 10, wherein the bulk particulate material comprises toner for use in an electrophotographic printing process, said desired particle size is less than approximately 10 microns.

17. A method for reducing the total energy required to reduce a particle size of a bulk particulate material to a desired particle size, comprising:
reducing in one or more first reducing stages the particle size of the bulk material to an intermediate particle size; and
further reducing in a final reducing stage the intermediate particle size to a desired particle size, said final reducing stage conducted separate from said first reducing stage.

18. A method for producing a bulk particulate material having a smaller particle size using a given amount of particle-reducing input energy, comprising:
reducing the particle size of the bulk material to an intermediate particle size in one or more first reducing stages; and
further reducing the intermediate particle size to a desired particle size in a final reducing stage, said final reducing stage conducted separate from said first reducing stage.

19. A bulk particulate material manufactured according to a process comprising:
reducing a particle size of the bulk material to an intermediate particle size in one or more first reducing stages; and
further reducing the particle size of the bulk material from the intermediate particle size to a desired particle size in a final reducing stage, said final reducing stage conducted separate from said first reducing stage.
